(19) United States
(12) Patent Application Publication
(10) Pub. No.: US 2014/0303924 A1
(43) Pub. Date: Oct. 9, 2014

(54) REFERENCE VALUE GENERATING METHOD AND REFERENCE VALUE GENERATING DEVICE

(71) Applicant: Seiko Epson Corporation, Tokyo (JP)

(72) Inventors: Anand Kumar, Richmond (CA); Shunichi Mizuochi, Matsumoto-shi (JP); Shuji Uchida, Shiojiri-shi (JP)

(21) Appl. No.: 14/352,683

(22) PCT Filed: Oct. 17, 2012
(86) PCT No.: PCT/JP2012/006642

§ 371 Date: Apr. 17, 2014

(30) Foreign Application Priority Data
Oct. 18, 2011 (JP) 2011-228777

(51) Int. Cl. G01C 25/00

(52) U.S. Cl. CPC G01C 25/00
USPC 702/94

(57) ABSTRACT

Based on a local coordinate velocity vector calculated by a local coordinate velocity vector calculation unit and an attitude angle calculated by an attitude angle calculation unit, a change portion of a detected value in the past that is similar to a change in a detected value of attitude and velocity during movement of the user is extracted as a correlation calculation unit provided in each of a reference velocity vector calculation unit and a reference attitude angle calculation unit carries out predetermined correlation calculation. Then, a reference value of the detected value used when correcting the detected value is calculated and generated by the reference velocity vector calculation unit and the reference attitude angle calculation unit, using the result of the extraction.

### TECHNICAL FIELD

The present invention relates to a method for generating a reference value used for correcting a detected value of one of attitude, velocity, angular velocity and acceleration detected during movement of a user, and the like.

### BACKGROUND ART

Utilization of sensors is receiving attention in various fields such as so-called seamless positioning, motion sensing and attitude control. As such sensors, acceleration sensors, gyro sensors, pressure sensors, geomagnetic sensors and the like are widely known. Techniques for calculating the position of a mobile body (for example, a bicycle, automobile, train, ship, airplane or the like) by inertial navigation calculation utilizing the result of measurement by a sensor are also devised.

Of these, techniques for calculating the position of a human by utilizing inertial navigation or the like, assuming the human as a mobile body, are disclosed in Patent Literatures 1 to 4.

### CITATION LIST

### Patent Literature

PTL 1: U.S. patent Ser. No. 11/379,269, Specification
PTL 2: U.S. patent Ser. No. 09/212,766, Specification
PTL 3: U.S. patent Ser. No. 08/405,087, Specification
PTL 4: U.S. patent Ser. No. 06/465,274, Specification

### SUMMARY OF INVENTION

### Technical Problem

For example, in the case of calculating a position during a walk by utilizing the result of measurement by a three-axis acceleration sensor, acceleration vectors as the result of measurement by the acceleration sensor are added up to find a velocity vector, and velocity vectors are added up to calculate the position. However, due to the influence of a bias or the like included in the result of measurement by the sensor, there is a problem that calculation errors of inertial navigation are accumulated as the adding up is repeated.

In short, in the technique for calculating a position during a walk, the accuracy of position calculation entirely depends on measurement errors of an inertial sensor installed in a position calculation device. Therefore, the measurement errors of the inertial sensor need to be corrected. To correct the measurement errors, a reference value that serves as a reference for correction is required. If there is an error in the reference value, the measurement errors cannot be corrected accurately.

In view of the foregoing problems, it is an object of the invention to propose a new technique for generating a reference value for correcting a measurement error during movement of a user.

### Solution to Problem

According to a first embodiment in order to solve the foregoing problems, a reference value generating method includes: storing a detected value of one of attitude, velocity, angular velocity, and acceleration detected during movement of a user, in a storage unit; extracting a change portion of the detected value in the past that is similar to a change in the detected value up to the present, from the storage unit; and generating a reference value of the detected value used when correcting the detected value, by using a result of the extraction.

Also, according to another embodiment, a reference value generating device includes: a storage unit that stores a detected value of one of attitude, velocity, angular velocity, and acceleration detected during movement of a user; an extraction unit that extracts a change portion of the detected value in the past that is similar to a change in the detected value up to the present, from the storage unit; and a generation unit that generates a reference value of the detected value used when correcting the detected value, by using a result of the extraction of the extraction unit.

According to this first embodiment and the like, a detected value of one of attitude, velocity, angular velocity, and acceleration detected during movement of a user is stored in a storage unit. Then, a change portion of the detected value in the past that is similar to a change in the detected value up to the present is extracted from the storage unit, and a reference value of the detected value used when correcting the detected value is generated by using a result of the extraction. By a simple technique of extracting a change portion of the detected value in the past that is similar to a change in the detected value up to the present, a reference value used when correcting one of attitude, velocity, angular velocity, and acceleration detected during movement of the user can be generated.

Also, as a second embodiment, the reference value generating method according to the first embodiment may be configured in such a way that the extracting includes extracting a change portion of the detected value in the past that is most similar to the change in the detected value.

According to this second embodiment, by extracting a change portion of the detected value in the past that is most similar to the change in the detected value, a proper value can be generated as the reference value of the detected value used when correcting the detected value.

Moreover, according to a third embodiment, the reference value generating method according to the first or second embodiment may be configured in such away that the extracting includes calculating a degree of similarity between the change in the detected value up to the present and the change in the detected value in the past, and that the method includes generating the reference value by using the latest detected value if the highest degree of similarity of the calculated degrees of similarity does not satisfy a predetermined high similarity condition.

If the reference value is generated using the change portion of the detected value in the past despite the low degree of similarity, there is a high possibility that the reference value is not a proper value. That is, even if the detected value is corrected with that reference value, there is a high possibility that the detected value cannot be corrected accurately. Thus, according to the third embodiment, if the highest degree of similarity, of the degrees of similarity between the change in the detected value up to the present and the change in the detected value in the past, does not satisfy a predetermined high similarity condition, the reference value is generated using the latest detected value. Thus, for example, in a circumstance where various amounts detected during movement of the user greatly change momentarily, such as where the user changes directions during movement, it is possible to generate a proper reference value suitable for the circumstance.

Also, according to a fourth embodiment, the reference value generating method according to one of the first to third embodiments may be configured in such a way that the extracting is, by using a time range for determination of the similarity defined on the basis of a landing time interval that is a time interval between neighboring peaks of acceleration of up and down movement of the user, extracting a change in the detected value in the time range in the past that is similar to a change in the detected value in the time range lasting up to the present as a terminal point.

According to this fourth embodiment, by using a time range for determination of the similarity defined on the basis of a landing time interval that is a time interval between neighboring peaks of acceleration of up and down movement of the user, a change in the detected value in the time range in the past that is similar to a change in the detected value in the time range lasting up to the present as a terminal point can be extracted properly. As a result, it is possible to generate a proper reference value.

Also, according to a fifth embodiment, the reference value generating method according to one of the first to fourth embodiments may be configured in such a way that the storage unit has a capacity equal to or greater than a predetermined capacity defined as a capacity for storing the detected value detected while the user takes two steps.

According to this fifth embodiment, since the storage unit is configured to have a capacity equal to or greater than a predetermined capacity defined as a capacity for storing the detected value detected while the user takes two steps, it is possible to extract a change portion of the detected value in the past that is similar to a change in the detected value up to the present, based on periodicity of attitude, velocity, angular velocity, and acceleration during a human's walking.

Moreover, according to a sixth embodiment, the reference value generating method according to one of the first to fifth embodiments may be configured to include: performing Kalman filtering to find an amount of correction of the detected value, using the reference value as observation information; correcting the detected value based on the amount of correction; and calculating the position using the detected value.

According to this sixth embodiment, since Kalman filtering to find the amount of correction of the detected value is performed by using the reference value found in one of the above embodiments as observation information, the amount of correction of the detected value can be found accurately. Then, by correcting the detected value based on the resulting amount of correction, and calculating the position using the detected value as a result of the correction, it is possible to calculate the position accurately.

Also, according to a seventh embodiment, the reference value generating method according to one of the first to fifth embodiments may be configured in such a way that at least a value indicating a velocity vector in absolute coordinates during movement of the user is included in the detected value, and that the method includes: adding up acceleration vectors defined on the basis of a measured value from an acceleration sensor and thus finding a velocity vector in absolute coordinates; adding up the velocity vectors and thus calculating a position in absolute coordinates: and correcting one of the adding up of the acceleration vectors and the adding up of the velocity vector, using the reference value.

According to this seventh embodiment, acceleration vectors defined on the basis of a measured value from an acceleration sensor are added up, thus finding a velocity vector in absolute coordinates. The resulting velocity vectors are added up, thus calculating a position in absolute coordinates. Then, one of the adding up of the acceleration vectors and the adding up of the velocity vector is corrected, using the reference value. Thus, accumulation of calculation errors generated in the case of repeating the adding up to calculate a position can be prevented.

### BRIEF DESCRIPTION OF DRAWINGS

FIG. 1 is an explanatory view of the system configuration of an overall system.

FIG. 2 is an explanatory view of the system configuration of INS.

FIG. 3 is an explanatory view of the functional configuration of a reference value generation unit.

FIG. 4 is a view showing an example of time change in a local coordinate velocity vector.

FIG. 5 is a view showing an example of time change in attitude angle.

FIG. 6 is a view showing an example of correlation calculation result.

FIG. 7 is a view of the system configuration of an INS calculation system.

FIG. 8 is a block diagram showing an example of the functional configuration of an INS calculation device.

FIG. 9 is a flowchart showing a flow of main processing.

FIG. 10 is a flowchart showing a flow of reference value generation processing.

### DESCRIPTION OF EMBODIMENTS

Hereinafter, an example of a preferred embodiment of the invention will be described with reference to the drawings. However, as a matter of course, embodiments to which the invention is applicable are not limited to the following embodiment.

### 1. Principle

### 1-1. Overall System

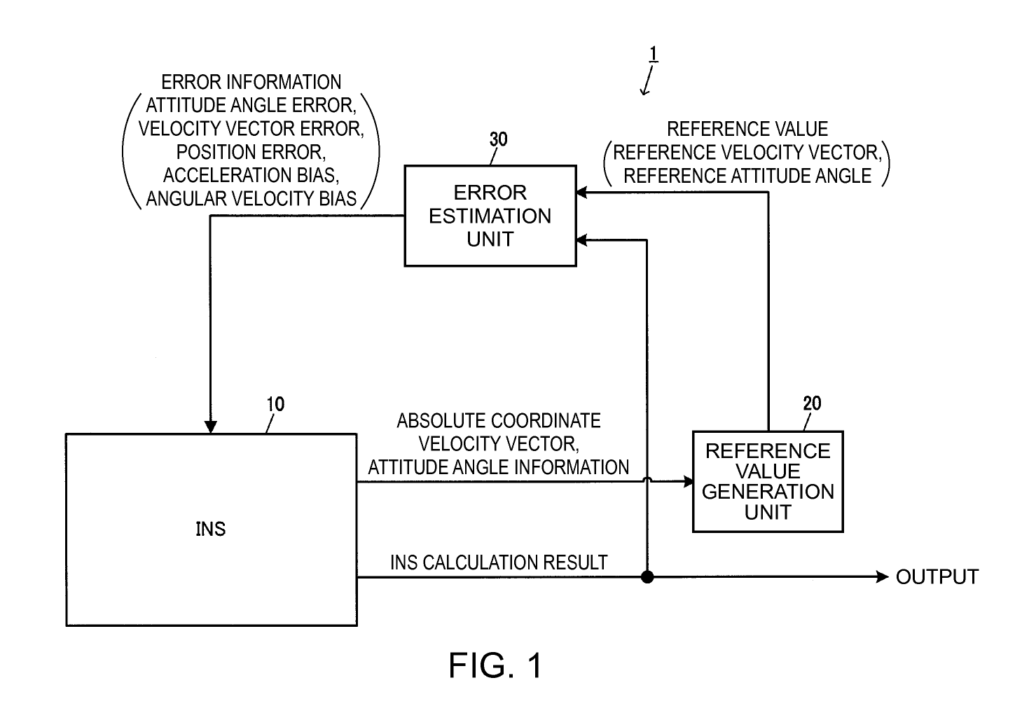

FIG. 1 is a view showing the schematic configuration of an overall system 1 in this embodiment. The overall system 1 includes an INS (Inertial Navigation System) 10, a reference value generation unit 20, and an error estimation unit 30.

In the drawings referred to below, a sensor block is indicated by double lines and a processing block which carries out calculation processing utilizing the result of measurement by a sensor is indicated by single lines. The processing block indicated by the single lines is, for example, a processing block in which a processor (host processor) installed in an electronic apparatus serves as an agent of processing. The agent of processing in each processing block can be suitably set according to the system to which the invention is applied.

In this embodiment, two types of coordinate systems are defined. A first coordinate system is a local coordinate system (sensor coordinate system) made up of a three-dimensional orthogonal coordinate system corresponding to a sensor. In this embodiment, three-axes of the local coordinate system are referred to as u-axis, v-axis, and w-axis.

A second coordinate system is an absolute coordinate system used as a reference when carrying out inertial navigation calculation. As the absolute coordinate system, for example, various coordinate systems such as a NED coordinate system known as a North East Down coordinate system, an ENU coordinate system known as an East North Up coordinate system, and an ECEF coordinate system known as an Earth Centered Earth Fixed coordinate system can be applied. In this embodiment, three axes of the absolute coordinate system are referred to as X-axis, Y-axis, and Z-axis.

Acceleration and velocity have a direction as well as a magnitude. In this embodiment, in principle, when the acceleration or velocity is mentioned, it is assumed that this refers to the magnitude (scalar quantity) of the acceleration or velocity, and when an acceleration vector or velocity vector is mentioned, it is assumed that this refers to the direction in addition to the magnitude (scalar quantity). Also, in order to clarify various amounts defined in each coordinate system, the type of the coordinate system is added to the beginning of the term that expresses each amount. For example, an acceleration vector expressed in a local coordinate system is referred to as a “local coordinate acceleration vector”, and an acceleration vector expressed in an absolute coordinate system is referred to as an “absolute coordinate acceleration vector”. The same applies to the other amounts.

The INS 10 is a system known as an inertial navigation system and configured to be capable of independent positioning. The INS 10 calculates and outputs a position, velocity (velocity vector), attitude angle and the like, based on the results of measurement by inertial sensors such as an acceleration sensor 5A, a gyro sensor 5B and a geomagnetic sensor, or by an IMU (Inertial Measurement Unit) having these inertial sensors packaged. The IMU is a sensor unit known as an inertial measurement unit and is configured to be capable of measuring and outputting an acceleration vector and an angular velocity vector expressed in a local coordinate system.

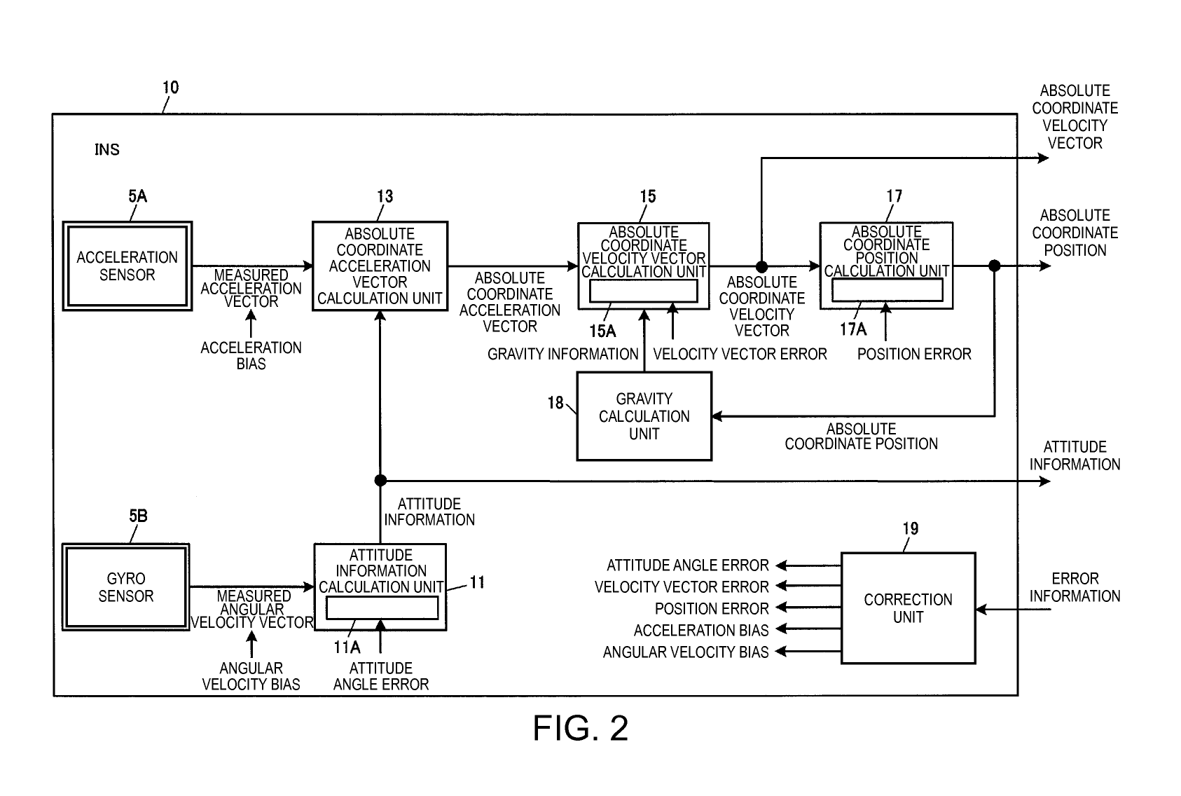

FIG. 2 is a view showing an example of the system configuration of the INS 10. The INS 10 has the acceleration sensor 5A and the gyro sensor 5B, as sensors. Also, the INS 10 has an attitude information calculation unit 11, an absolute coordinate acceleration vector calculation unit 13, an absolute coordinate velocity vector calculation unit 15, an absolute coordinate position calculation unit 17, a gravity calculation unit 18, and a correction unit 19, as processing blocks.

The acceleration sensor 5A is a sensor which measures an acceleration vector in a local coordinate system. Meanwhile, the gyro sensor 5B is a sensor which measures an angular velocity vector in a local coordinate system. As these sensors, for example, a MEMS sensor utilizing the technique of MEMS (Micro Electro Mechanical Systems) is used.

The attitude information calculation unit 11 calculates the latest attitude information, using the angular velocity vector measured by the gyro sensor 5B and attitude information stored in an attitude information storage unit 11A. The attitude information means information indicating an attitude defined on the basis of various attitude expressions, for example, quaternion, direction cosine matrix (hereinafter referred to “DCM”), or Euler angles. The various attitude expressions are already known in the related art and therefore detailed description thereof is omitted here. The attitude information calculation unit 11 causes the attitude information storage unit 11A to store the calculated latest attitude information.

The absolute coordinate acceleration vector calculation unit 13 calculates the latest absolute coordinate acceleration vector, using the local coordinate acceleration vector measured by the acceleration sensor 5A and the attitude information inputted from the attitude information calculation unit 11. Specifically, the local coordinate acceleration vector is coordinate-transformed into an absolute coordinate acceleration vector, thus calculating the latest absolute coordinate acceleration vector. Since a known technique can be used for the coordinate transformation, description thereof is omitted.

The absolute coordinate velocity vector calculation unit 15 calculates an absolute coordinate velocity vector, using the absolute coordinate acceleration vector inputted from the absolute coordinate acceleration vector calculation unit 13, gravity information inputted from the gravity calculation unit 18, and the absolute coordinate velocity vector stored in an absolute coordinate velocity vector storage unit 15A. In this case, the direction of gravity and the Coriolis force are corrected, based on the gravity information and the stored absolute coordinate velocity vector. Since the earth is elliptical, the latitude as viewed from the center of the earth is different from the geographical latitude. Therefore, correction of the direction of gravity is needed. Since the earth revolves with respect to the inertial space of the universe, correction of the Coriolis force is needed, too.

The absolute coordinate velocity vector calculation unit 15 adds up the absolute coordinate acceleration vectors to the absolute coordinate velocity vector stored in the absolute coordinate velocity vector storage unit 15A, thus calculating the latest absolute coordinate velocity vector, in consideration of the direction of gravity as described above. Then, the calculated latest is stored in the absolute coordinate velocity vector storage unit 15A.

The absolute coordinate position calculation unit 17 adds up the absolute coordinate velocity vectors inputted from the absolute coordinate velocity vector calculation unit 15 to the absolute coordinate position stored in an absolute coordinate position storage unit 17A, thus calculating an absolute coordinate position. Then, the calculated latest absolute position coordinates are stored in the absolute coordinate position storage unit 17A.

The gravity calculation unit 18 calculates gravity information, using the absolute coordinate position inputted from the absolute coordinate position calculation unit 17, and outputs the gravity information to the absolute coordinate velocity vector calculation unit 15.

The correction unit 19 corrects the cumulative value calculated by each calculation unit, using error information estimated by the error estimation unit 30. Specifically, the measured angular velocity vector is corrected using an angular velocity bias included in the error information. Also, the attitude information stored in the attitude information storage unit 11A is corrected, using an attitude angle error included in the error information. Moreover, the measured acceleration vector is corrected, using an acceleration bias included in the error information.

Also, the absolute coordinate velocity vector stored in the absolute coordinate velocity vector storage unit 15A is corrected, using a velocity vector error included in the error information, and the absolute coordinate position stored in the absolute coordinate position storage unit 17A is corrected, using a position error included in the error information.

Ultimately, the attitude information, the absolute coordinate velocity vector and the absolute coordinate position are outputted from the INS 10 as the result of calculations.

### 1-2. Method for Generating Reference Value

Back to FIG. 1, the reference value generation unit 20 generates a reference value that is used as observation information when the error estimation unit 30 carries out Kalman filtering to find the amount of correction of attitude, velocity, acceleration, position and the like. It can be said that the reference value generation unit 20 is a device that generates a reference value (reference value generating device).

The inventor of the present application has confirmed, based on an experiment, that when the user moves by walking or running, periodicity emerges in each axis component of the local coordinate velocity vector and each axis component of the attitude angle. Based on such a finding, calculated values of attitude and velocity during the movement of the user are stored in the storage unit. Then, a change portion of the calculated values in the past that is similar to a change in the calculated values up to the present is extracted, and a reference value is generated using the result of the extraction. Each of the results of measurement by the inertial sensors and the calculated values calculated in each processing block is an example of the detected value of one of attitude, velocity, angular velocity and acceleration.

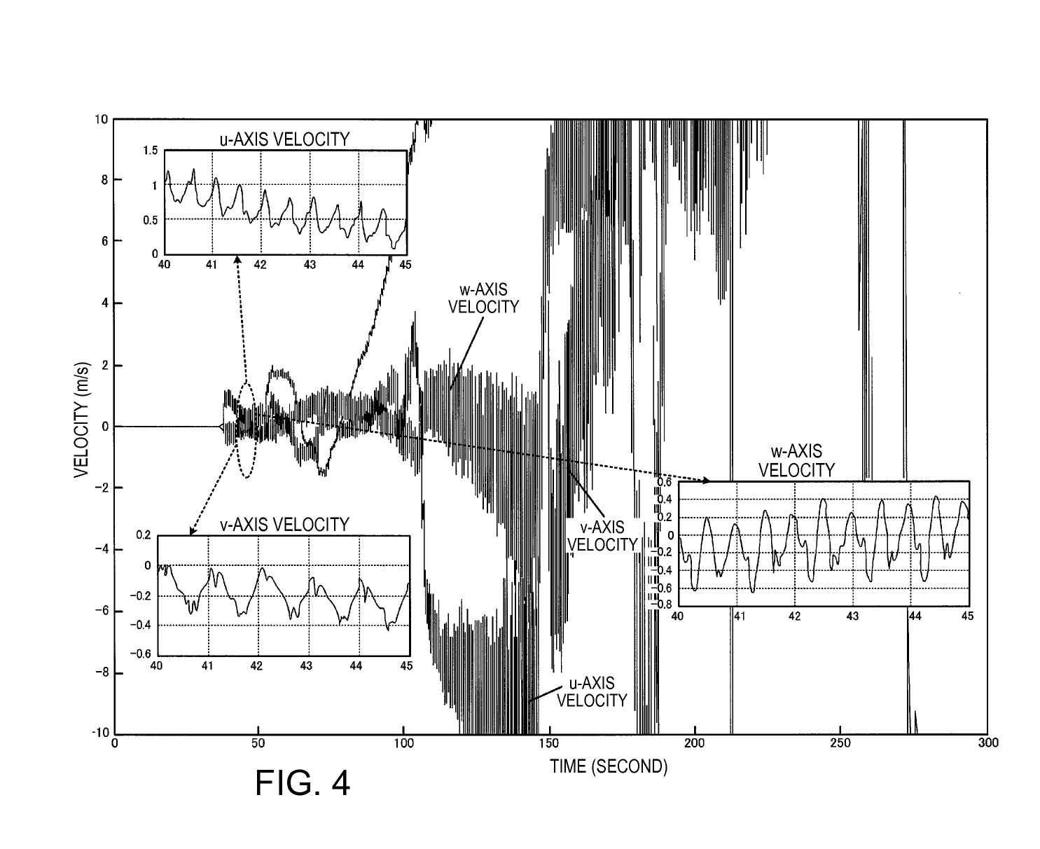

FIG. 4 is an example of the result of an experiment showing time change in the local coordinate velocity vector obtained when the user is walking. FIG. 4 shows the result of calculating the velocities on the u-axis, v-axis and w-axis, respectively, by installing an inertial sensor on the user's waist and then adding up the accelerations on the u-axis, v-axis and w-axis, respectively (however, the gravity component is excluded from the adding up). The horizontal axis is the time axis, and the vertical axis represents values of velocity. From the result of this experiment, it can be seen that the velocity component on each of the u-axis, v-axis and w-axis has periodic changes accompanying the user's walk. This is because a human tends to have the same gait in substantially constant cycles when walking.

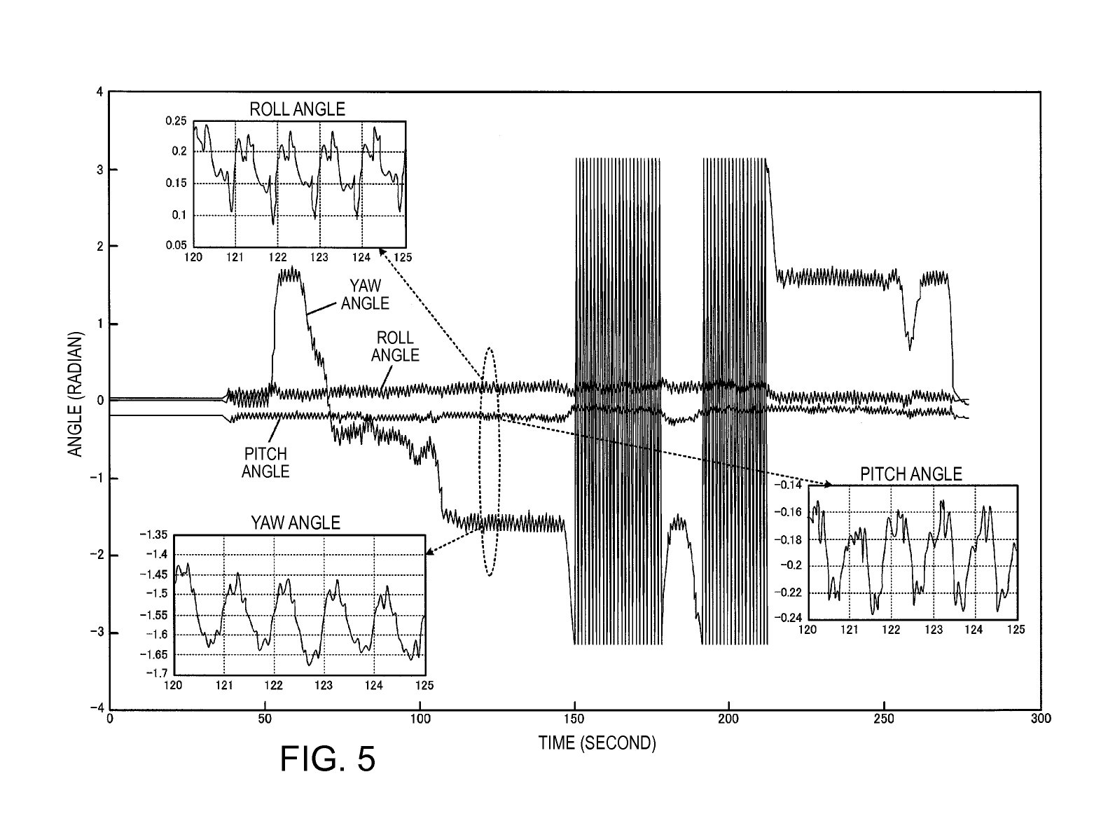

FIG. 5 is an example of the result of an experiment showing time change in the attitude angle obtained when the user is walking. The experiment method is similar to the above. FIG. 5 shows a roll angle, pitch angle and yaw angle that are found by updating the attitude, utilizing the angular velocity vectors about the u-axis, v-axis and w-axis. The horizontal axis is the time axis, and the vertical axis represents values of attitude angle. As seen from the result of this experiment, each of the roll angle, pitch angle and yaw angle tends to have periodic changes while the user is moving straightforward. However, periodicity does not emerge in the yaw angle when the user changes directions. When the user changes directions, the calculated value of the yaw angle largely changes momentarily.

By the way, while the above is the result of an experiment where an inertial sensor is installed on a human's waist, similar measurements have been tried in various states such as the state where an inertial sensor is held by the user's hand, the state where an inertial sensor is placed in the user's chest pocket and the state where an inertial sensor is placed in the user's bag. As a result, it has been confirmed that periodicity emerges in the local coordinate velocity vector and the attitude angle irrespective of the place where the inertial sensor is installed.

This embodiment focuses on the above periodicity, and a reference value is generated with respect to each of the velocity component on each axis of the local coordinate velocity vector and the component on each axis of the attitude angle by utilizing a value detected in the past (calculated value in the past). Specifically, a change in the detected value in a predetermined time range in the past that is similar to a change in the detected value in the same time range up to the present as a terminal point is extracted. As this method, correlation calculation is used in this embodiment.

Details will now be explained. First, the data string of the detected value in a predetermined time range (for example, one second) up to the present as a terminal point is selected. This data string is fixed. Meanwhile, the data string of the detected value in the past in the same time range (for example, one second) is selected while the period for selection (one second at which time point) is shifted. Then, correlation calculation to compare each of the selected data strings with the data string lasting up to the present as a terminal point is carried out, thus calculating a correlation value (degree of similarity). The correlation calculation is carried out by convolution calculation. By calculating correlations while shifting the data string selected from a predetermined period (for example, a period from the present to three seconds ago), a change portion of the detected value in the past that is most similar to the change in the detected value up to the present can be extracted.

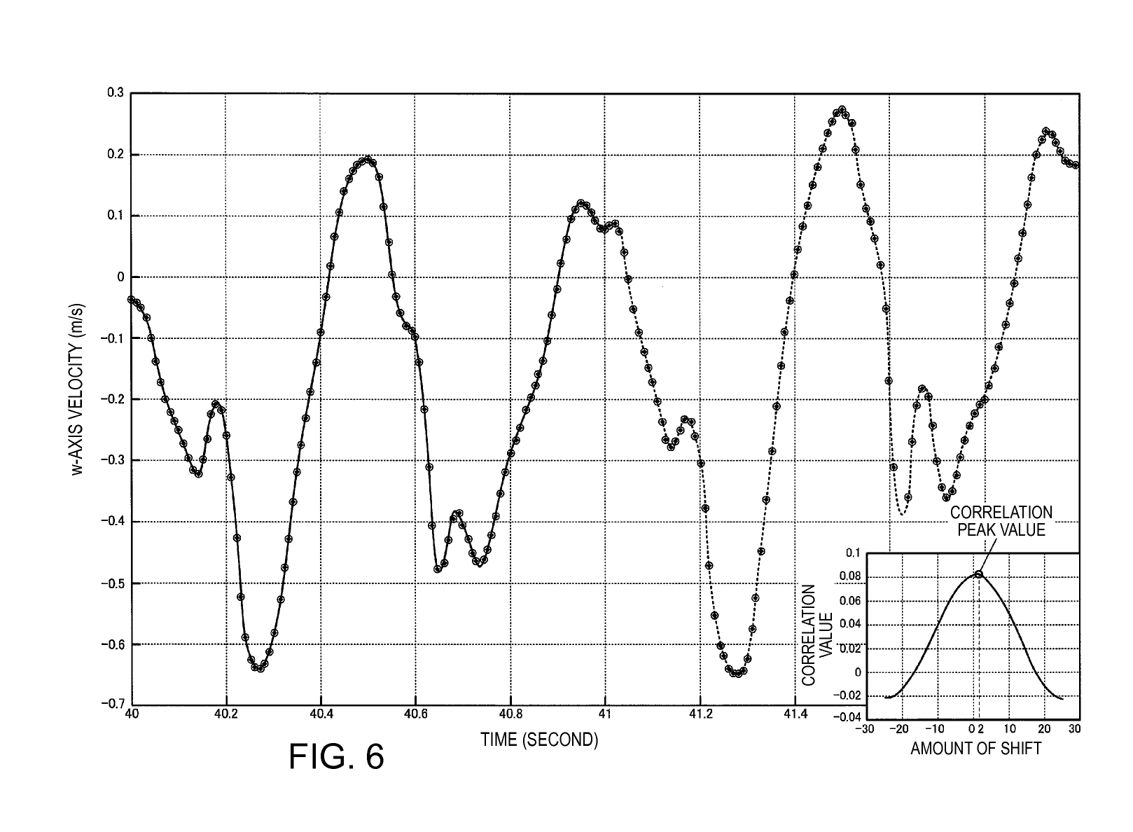

FIG. 6 is a view for explaining the correlation calculation in this embodiment. FIG. 6 shows an illustration about the velocity component on the w-axis, of the local coordinate velocity vector. The horizontal axis is the time axis, and the vertical axis represents velocity. The time “41 [seconds]” at the center in left-right directions in FIG. 6 is used as a reference. A predetermined number of continuing detected values, of the detected values (sample values) indicated by solid lines on the left-hand side, form a first data string. A predetermined number of detected values, of the detected values indicated by dotted lines on the right-hand side, form a second data string. However, the “predetermined number” is defined as the number of samples that is equivalent to or greater than the time required for taking two steps. Then, the result of shifting the selection position of the first data string in the direction of the time axis and calculating correlation with the second data string is shown in the bottom right part of FIG. 6. In this FIG. 6, the horizontal axis represents the amount of shift of the detected value, and the vertical axis represents correlation values.

As seen from the result, the highest correlation is obtained when the first data string is shifted by “+2 samples”. Then, it can be seen that this correlation value is a peak (correlation peak value) and that the correlation value decreases as the selection position of the first data string is shifted further. However, though not shown, as the amount of shift is increased further, the correlation value turns from decrease to increase and a peak-like value similar to the case where a shift by “+2 samples” is made is shown. Therefore, it can be inferred that the detected value periodically changes during the movement of the user. Thus, by using a data string having cycles at the latest detected value as the second data string and calculating correlations while shifting the first data string in the direction of the time axis, a change portion of the detected value in the past that is similar to a change in the detected value up to the present can be extracted.

Also, it can be said that the detected values forming the first data string in the case where a shift of “+2 samples” is made and where the correlation value peaks, and the detected values forming the second data string are proximate values to each other when compared in order of time. Therefore, if a change portion of the detected value in the past that is similar to a change in the detected value up to the present can be extracted, it is possible to select a past detected value that should be proximate to the latest detected value, from the extracted change portion. When correcting the latest detected value, the past detected value that should be proximate to the latest detected value, corresponding to the latest detected value, can be used as a reference value.

In this embodiment, correlation calculation is carried out by convolution calculation. Also, the second data string is fixed and only the first data string is shifted in the direction of the time axis. Therefore, the detected value at the terminal end of the second data string is used as the latest detected value, and the result of correlation calculation is made to correspond to the detected value at the terminal end of the first data string, which is shifted and selected. By doing so, the detected value corresponding to the highest correlation value can be easily determined as the past detected value that should be proximate to the latest detected value.

By the way, while the explanation about velocity is given with reference to FIG. 6, a similar explanation applies to the attitude angle. Also, when calculating correlations, it is preferable to execute digital signal processing such as band-pass filtering to cut the DC component of the signal and then calculate the correlation with the AC component of the signal, with respect to each component of the local coordinate velocity vector and each component of the attitude angle.

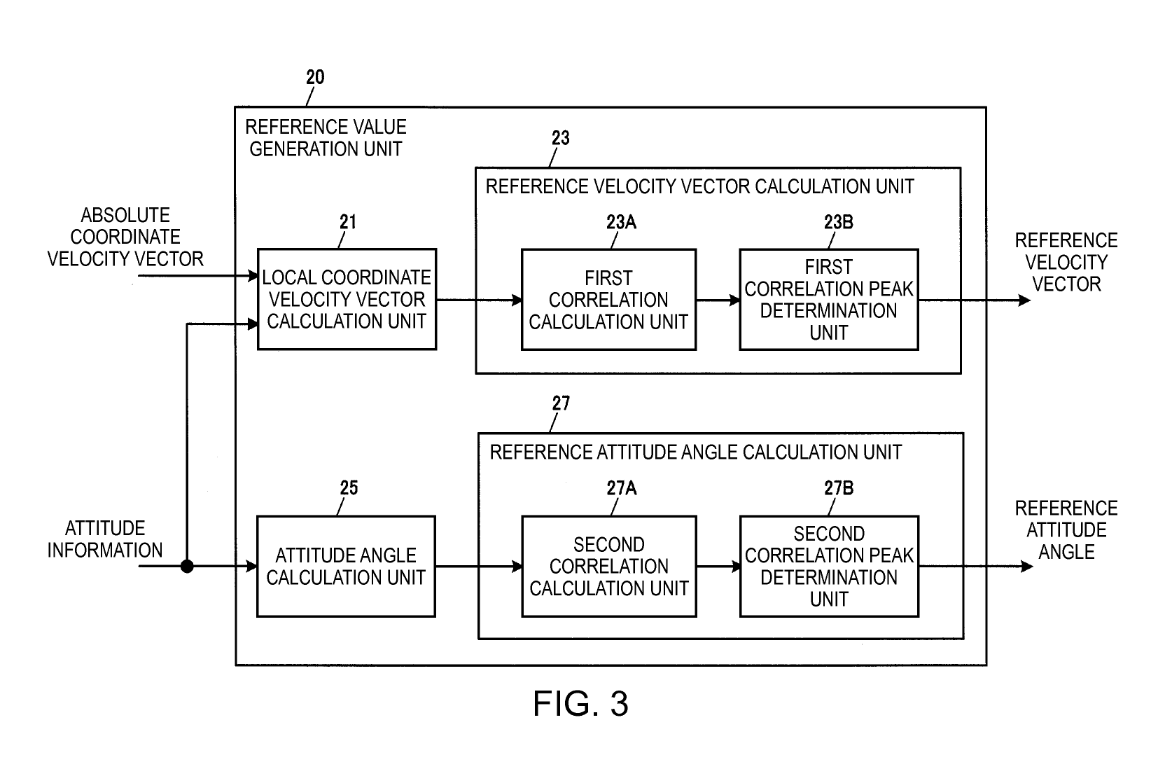

Reference is now made back to FIG. 3. FIG. 3 is a view showing an example of the functional configuration of the reference value generation unit 20. The reference value generation unit 20 has a local coordinate velocity vector calculation unit 21, a reference velocity vector calculation unit 23, an attitude angle calculation unit 25, and a reference attitude angle calculation unit 27.

The local coordinate velocity vector calculation unit 21 coordinate-transforms the absolute coordinate velocity vector inputted from the INS 10, using the attitude information inputted similarly from the INS 10, and thus calculates the local coordinate velocity vector.

The reference velocity vector calculation unit 23 stores the local coordinate velocity vector inputted from the local coordinate velocity vector calculation unit 21, in a storage unit in a historical manner in association with time, and reads out past data with respect to each velocity component on each axis of the local coordinate velocity vector and carries out correlation calculation according to the above principle.

The reference velocity vector calculation unit 23 has a first correlation calculation unit 23A and a first correlation peak determination unit 23B. The reference velocity vector calculation unit 23 is equivalent to a generation unit that generates a reference value. Also, the first correlation calculation unit 23A and the first correlation peak determination unit 23B are equivalent to an extraction unit that extracts a change portion of the detected value in the past that is similar to a change in the detected value up to the present.

The first correlation calculation unit 23A carries out first correlation calculation with respect to the past local coordinate velocity vector stored in a historical manner. The correlation calculation is done as described in the above principle. Thus, which of the past calculated values has the highest correlation with the present calculated value is determined.

The first correlation peak determination unit 23B determines the correlation peak value, based on the result of the correlation calculation by the first correlation calculation unit 23A. If a calculated value having a high correlation with the present calculated value exists in the past, the correlation peak value is a relatively large value. However, a calculated value having a high correlation with the present calculated value does not exist in the past, the correlation peak value is a relatively small value. Thus, if the correlation peak value exceeds a predetermined threshold value, the correlation peak value is determined as “OK”. On the other hand, if the correlation peak value does not exceed the predetermined threshold value, the correlation peak value is determined as “NG”.

If the correlation peak value is determined as “OK” by the first correlation peak determination unit 23B, the past detected value is read out on the basis of the correlation peak value and the amount of shift and is set as a reference value. Meanwhile, if the correlation peak value is determined as “NG”, the latest detected value of velocity is set as a reference value. In short, if no correlation is found, the latest detected value is used as reference value instead of using the past detected value. This is equivalent to generating a reference value by using the latest detected value of velocity if the highest degree of similarity of the calculated degrees of similarity does not satisfy a predetermined high similarity condition.

The attitude angle calculation unit 25 calculates the attitude angle using the attitude information inputted from the INS 10. The attitude angle is a three-axis rotation angle between the local coordinates and the absolute coordinates and is expressed by Euler angles, that is, roll angle, pitch angle, and yaw angle. If the attitude information inputted from the INS 10 is a quaternion, the quaternion is transformed into to Euler angles. Meanwhile, if the attitude information inputted from the INS 10 is a DCM, the DCM is transformed into Euler angles. Since these transformations are known in the related art, explanation thereof is omitted here.

The reference attitude angle calculation unit 27 calculates the reference attitude angle using the attitude angle inputted from the attitude angle calculation unit 25. In this case, the respective components of the attitude angle calculated by the attitude angle calculation unit 25 are stored in three storage units, respectively.

The reference attitude angle calculation unit 27 has a second correlation calculation unit 27A and a second correlation peak determination unit 27B. The method for correlation calculation carried out by the second correlation calculation unit 27A and the method for correlation peak determination carried out by the second correlation peak determination unit 27B are similar to the above.

If the correlation peak value exceeds a predetermined threshold value, the reference attitude angle calculation unit 27 determines the correlation peak value as “OK”. On the other hand, if the correlation peak value does not exceed the predetermined threshold value, the reference attitude angle calculation unit 27 determines the correlation peak value as “NG”. Then, if the correlation peak value is determined as “OK”, the past detected value is read out on the basis of the correlation peak value and the amount of shift and is set as a reference value of the attitude angle. Meanwhile, if the correlation peak value is determined as “NG”, the latest detected value of attitude angle is set as a reference value.

For example, if the user changes directions while walking, the yaw angle largely changes momentarily. Therefore, if correlation calculation is carried out with respect to the yaw angle at the time of direction change, a good correlation cannot be found and the correlation peak value tends to be small. As a result, the correlation peak does not exceed the threshold value, and the correlation peak value is determined as “NG”. That is, if the user changes directions while walking, due to the lack of correlation, the latest detected value of the yaw angle is set as a reference value instead of the past detected value of the yaw angle.

### 1-3. Error Estimating Method and Correction Method

Back to FIG. 1, the error estimation unit 30 carries out predetermined error estimation calculation using the reference value generated by the reference value generation unit 20 and thus estimates an error included in each of various amounts calculated by the INS 10. As a technique for error estimation, various techniques can be applied. However, in this embodiment, the case of applying Kalman filtering is illustrated.

Specifically, for example, a state vector “X” having an error in the attitude information calculated by the INS 10 (attitude error), an error in the absolute coordinate velocity vector (velocity vector error), an error in the absolute coordinate position (position error), a bias of the acceleration sensor 5A (acceleration bias) and a bias of the gyro sensor 5B (gyro bias), as components, is set. Also, the INS calculation result outputted from the INS 10 is set as an input vector “U” (control input).

Moreover, the difference between the absolute coordinate reference velocity vector expressing the reference velocity vector in the form of absolute coordinates, and the absolute coordinate velocity vector inputted from the INS 10, is calculated as observation information related to the velocity. Also, the difference between the reference attitude angle and the attitude angle found from the attitude angle information inputted from the INS 10 is calculated as observation information related to the attitude angle. Then, an observation vector “Z” having these differences as components is set.

The state vector “X”, the input vector “U” and the observation vector “Z” are set as described above, and prediction calculation based on the theory of Kalman filtering (time update) and correction calculation (observation update) are carried out, thus finding an estimated value of the state vector “X” (state estimated value). Each component of the state estimated value is error information. This is equivalent to carrying out Kalman filtering to find the amount of correction of the detected value, using the reference value as observation information.

The error information estimated by the error estimation unit 30 is fed back to the INS 10. Then, based on the error information thus fed back, the adding-up executed in each processing block of the INS 10 is corrected by the correction unit 19 using the error information, as described above. This is equivalent to correcting the detected value based on the amount of correction, or calculating the position using the detected value.

### 2. Example

Next, an example of an electronic apparatus to which the reference value generation device described in the principle section is applied will be explained. However, as a matter of course, examples to which the invention is applicable is not limited to the following example.

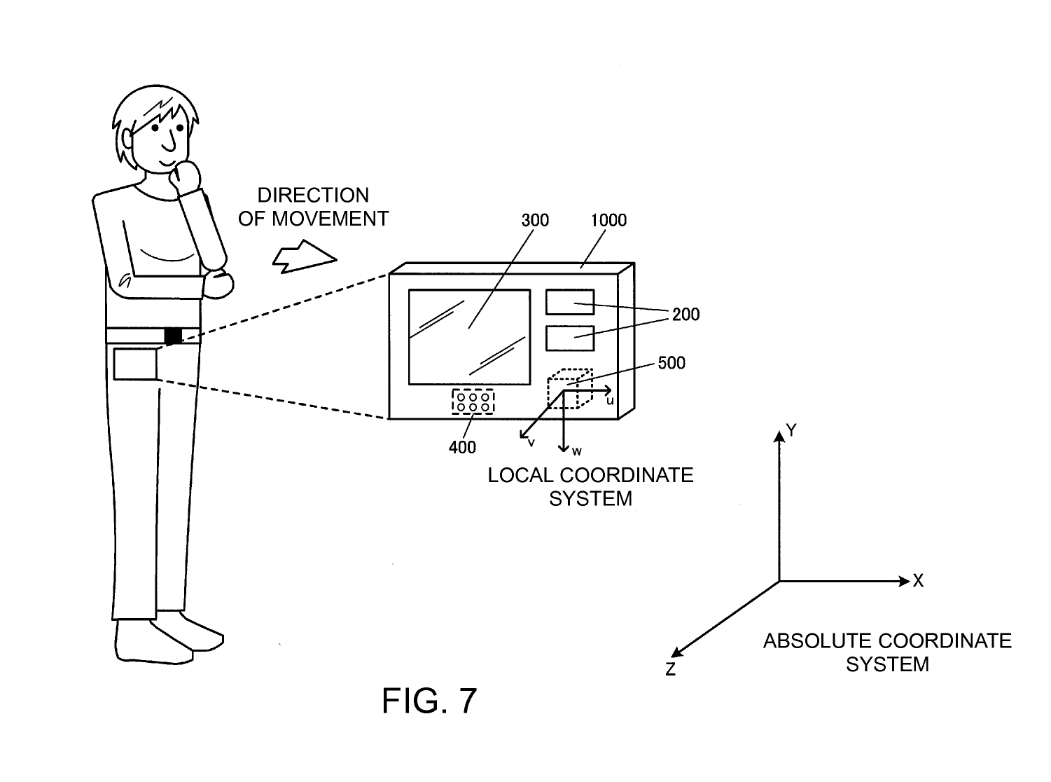

FIG. 7 is a view showing an example of the schematic configuration of an INS calculation system in this example. The INS calculation system includes an INS calculation device 1000 installed on a human. The INS calculation device 1000 is installed, for example, on the right-hand side of the user's waist when in use. When the user does exercise such as walking or running, the user does the exercise in the state where the device is installed on the right-hand side of the waist. As information of position and the like is stored in a historical manner, the user can check the moving route later. By connecting the INS calculation device 1000 to a personal computer or the like, the user can edit various kinds of information such as exercise record.

The INS calculation device 1000 has an IMU 500 as a sensor unit having the acceleration sensor 5A and the gyro sensor 5B, and measures an acceleration vector and an angular velocity vector in the local coordinate systems corresponding to the IMU 500. Also, the INS calculation device 1000 has a reference value generation device and generates a reference value used when correcting the detected value of each of various amounts such as the position of the user, velocity vector and attitude angle. Then, using the generated reference value, the INS calculation result is corrected as described in the principle section.

### 2-1. Functional Configuration

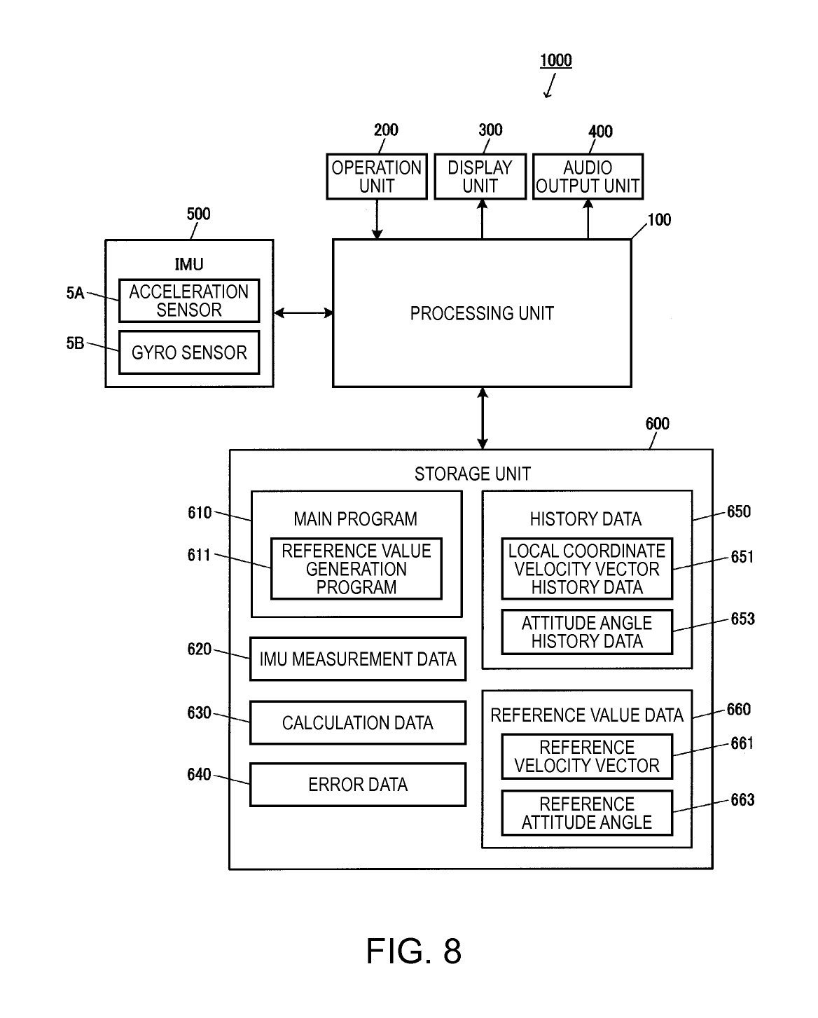

FIG. 8 is a block diagram showing an example of the functional configuration of the INS calculation device 1000. The INS calculation device 1000 includes, as the main functional configuration thereof, a processing unit 100, an operation unit 200, a display unit 300, an audio output unit 400, the IMU 500, and a storage unit 600.

The processing unit 100 is a control device and calculation device that comprehensively controls each part of the INS calculation device 1000 according to various programs such as a system program stored in the storage unit 600, and has a processor such as CPU (Central Processing Unit) or DSP (Digital Signal Processor).

The operation unit 200 is an input device including, for example, a touch panel, a button switch and the like, and outputs a signal of a pressed key or button to the processing unit 100. By the operation of this operation unit 200, various instruction inputs such as the start of the exercise and the end of the exercise are made.

The display unit 300 includes an LCD (Liquid Crystal Display) or the like and carries out various displays based on a display signal inputted from the processing unit 100. On the display unit 300, the information of position, velocity vector, attitude angle and the like as the INS calculation result is displayed.

The audio output unit 400 is an audio output device including a speaker or the like and carries out various audio outputs based on an audio output signal outputted from the processing unit 100. From the audio output unit 400, an audio guidance, a pace sound related to walking or running, and the like are outputted as sounds.

The storage unit 600 includes a storage device such as ROM (Read Only Memory), flash ROM or RAM (Random Access Memory) and stores the system program of the INS calculation device 1000 and various programs, data and the like for realizing various functions such as INS calculation. Also, the storage unit 600 has a work area for temporarily storing data that is being processed in various kinds of processing, processing results and the like.

### 2-2. Data Configuration

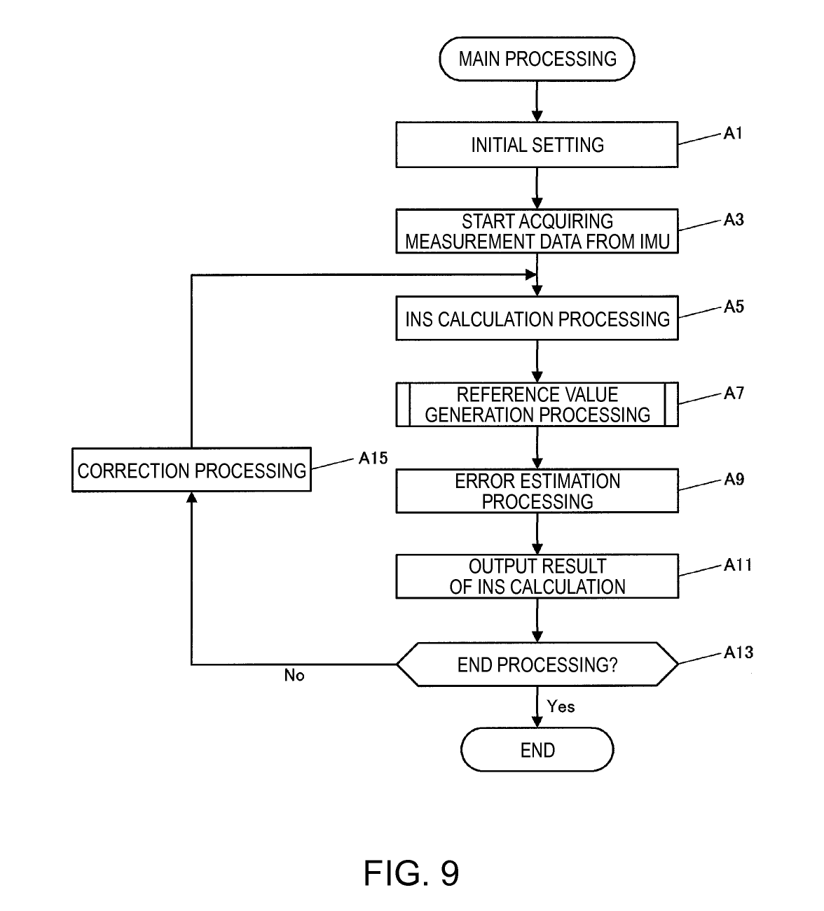

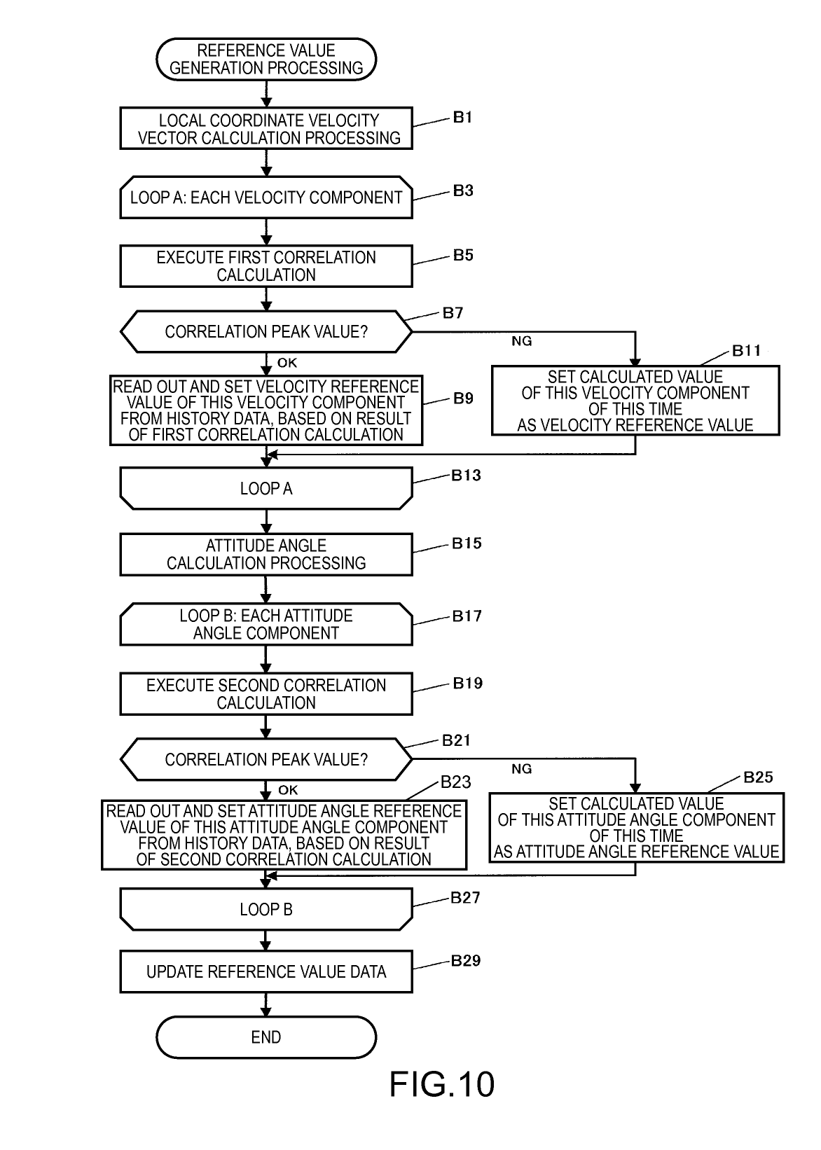

In the storage unit 600, a main program 610 that is read out and executed as main processing (see FIG. 9) by the processing unit 100 is stored as a program. The main program 610 includes a reference value generation program 611 executed as reference value generation processing (see FIG. 10) as subroutine. These processings will be described in detail later with reference to flowcharts.

Also, in the storage unit 600, IMU measurement data 620, calculation data 630, error data 640, history data 650, and reference value data 660 are stored as data.

The IMU measurement data 620 is data of the result of measurement by the IMU 500. For example, the local coordinate acceleration vector measured by the acceleration sensor and the local coordinate angular velocity vector measured by the gyro sensor 5B are stored in time series.

The calculation data 630 is data in which the result of INS calculation calculated by performing INS calculation processing is stored. Data that is being processed in relation to the various amounts found in the process of inertial navigation calculation by the INS 10 of FIG. 2 is included in this data.

The error data 640 is data in which the INS calculation error calculated by performing error calculation processing is stored. The error in the result of INS calculation obtained as a result of the error estimation calculation by the error estimation unit 30 of FIG. 1 is included in this data.

The history data 650 is data of history used to generate a reference value. Local coordinate velocity vector history data 651 in which the result of calculation by the local coordinate velocity vector calculation unit 21 of FIG. 3 is stored in a historical manner, and attitude angle history data 653 in which the result of calculation by the attitude angle calculation unit 25 is stored in a historical manner, are included in this data.

As a capacity for storing the history data 650, a predetermined capacity or more, defined as a necessary capacity to store a detected value that is detected while a human takes two steps, is prepared in advance.

Specifically, in this embodiment, assuming a walking velocity in the case of a slow walk, a necessary capacity to store a detected value that is detected while two steps are taken at this velocity is decided. To formulate this, a capacity “L” is calculated according to the following equation (1).

L=fₛ×2×Tₘₐₓ×amount of data detected in one detection (1)

In the equation (1), “fₛ” is the frequency at which the INS 10 carries out adding-up. “Tₘₐₓ” is the cycle in the case where the slowest velocity is assumed.

The reference value data 660 is data of a reference value generated by performing reference value generation processing. A reference velocity vector 661 as the result of calculation by the reference velocity vector calculation unit 23 of FIG. 3, and a reference attitude angle 663 as the result of calculation by the reference attitude angle calculation unit 27, are included in this data.

### 2-3. Flow of Processing

FIG. 9 is a flowchart showing the flow of the main processing executed by the processing unit 100 according to the main program 610 stored in the storage unit 600.

First, the processing unit 100 carries out initial setting (step A1). For example, in error estimation processing, initial setting of various parameter values (Kalman filter parameter values) used in Kalman filtering is carried out.

Next, the processing unit 100 starts acquiring data from the IMU 500 and stores the acquired data in the storage unit 600 as the IMU measurement data 620 (step A3). Then, the processing unit 100 carries out INS calculation processing using the IMU measurement data 620 and stores the result of the calculation in the storage unit 600 as the calculation data 630 (step A5). After that, the processing unit 100 carries out reference value generation processing according to the reference value generation program 611 stored in the storage unit 600 (step A7).

FIG. 10 is a flowchart showing the flow of the reference value generation processing.

First, the processing unit 100 carries out local coordinate velocity vector calculation processing (step B1). Then, the processing unit 100 carries out the processing of a loop A with respect to each velocity component forming the calculated local coordinate velocity vector (steps B3 to B13). In the processing of the loop A, the processing unit 100 carries out first correlation calculation (step B5).

Next, the processing unit 100 determines whether a correlation peak value that is the highest correlation value, of the correlation values (degrees of similarity) found as the result of the first correlation calculation, exceeds a predetermined threshold value or not (whether a predetermined high similarity condition is satisfied or not) (step B7). If the result of the determination of the correlation peak value is “OK” (step B7: OK), the processing unit 100 reads out a detected value corresponding to the highest correlation value from the local coordinate velocity vector history data 651 and sets the detected value as a velocity reference value, as described in the principle section (step B9).

On the other hand, if the result of the determination of the correlation peak value is “NG” (step B7: NG), the processing unit 100 sets the calculated value of the velocity component of this time as a velocity reference value (step B11). After step B9 or B11, the processing unit 100 shifts the processing to the next velocity component. As the processing of steps B5 to B11 is complete with respect to all the velocity components, the processing unit 100 ends the processing of the loop A (step B13).

Next, the processing unit 100 carries out attitude angle calculation processing (step B15). Then, the processing unit 100 carries out the processing of a loop B with respect to each attitude angle component (steps B17 to B27). In the processing of the loop B, the processing unit 100 carries out second correlation calculation (step B19).

Next, the processing unit 100 determines whether a correlation peak value that is the highest correlation value, of the correlation values (degrees of similarity) found as the result of the second correlation calculation, exceeds a predetermined threshold value or not (whether a predetermined high similarity condition is satisfied or not) (step B21). If the result of the determination of the correlation peak value is “OK” (step B21: OK), the processing unit 100 sets a detected value corresponding to the highest correlation value from the attitude angle history data 653 as an attitude angle reference value, as described in the principle section (step B23).

On the other hand, if the result of the determination of the correlation peak value is “NG” (step B21: NG), the processing unit 100 sets the calculated value of the attitude angle component of this time as an attitude angle reference value (step B25). After step B23 or B25, the processing unit 100 shifts the processing to the next attitude angle component. As the processing of steps B19 to B25 is complete with respect to all the attitude angle components, the processing unit 100 ends the processing of the loop B (step B27).

Next, the processing unit 100 updates the reference value data 660 in the storage unit 600, based on the velocity reference value that is set in step B9 or B11 with respect to each velocity component and the attitude angle reference value that is set in step B23 or B25 with respect to each attitude angle component (step B29). Then, the processing unit 100 ends the reference value generation processing.

Back to the main processing of FIG. 9, after carrying out the reference value generation processing, the processing unit 100 carries out error estimation processing (step A9). That is, Kalman filtering is carried out using the reference value data 660 generated in the reference value generation processing as observation information, thus estimating an error included in the calculation data 630 in the INS calculation processing. Then, the estimated error (amount of correction) is stored in the storage unit 600 as the error data 640.

Next, the processing unit 100 outputs the result of INS calculation (step A11). After that, the processing unit 100 determines whether to end the processing or not (step A13). If it is determined that the processing should continue (step A13: No), correction processing is carried out (step A15). That is, each calculation result included in the calculation data 630 is corrected, using the error (amount of correction) of each calculation result stored in the error data 640.

Meanwhile, if it is determined in step A13 that the processing should end (step A13: Yes), the processing unit 100 ends the main processing.

### 3. Effects and Advantages

According to this embodiment, a detected value of attitude and velocity detected during movement of the user is stored in the storage unit. Then, a change portion of the detected value in the past that is similar to a change in the detected value up to the present is extracted from the storage unit, and a reference value for the detected value used when correcting the detected value is generated by using the result of the extraction. By the simple method of extracting a change portion of the detected value in the past that is similar to a change in the detected value up to the present, a reference value used when correcting the detected value of attitude and velocity detected during movement of the user can be generated. In this case, for example, by extracting a change portion of the detected value in the past that is most similar to a change in the detected value up to the present, a proper reference value can be generated.

In this embodiment, each velocity component of the local coordinate velocity vector and each component of the attitude angle are detected every moment. A partial data string is selected from the detected data string while a predetermined time range for selection is shifted. Then, correlation calculation to compare each of the selected data strings with a data string in the same time range lasting to the present as a terminal end is carried out, thus calculating a correlation value (degree of similarity). Then, a data string with a maximum correlation value is specified and a reference value is set from the data included in that data string.

Also, whether the maximum correlation value exceeds a predetermined threshold value, that is, whether the highest degree of similarity satisfies a predetermined high similarity condition or not, is determined. If the predetermined threshold value is not exceeded (the high similarity condition is not satisfied), this is considered as a circumstance where various amounts detected during movement of the user largely change momentarily, for example, a circumstance where the user changes directions while moving. Therefore, in this case, the latest detected value is used to set a reference value.

### 4. Modification

Examples to which the invention is applicable are not limited to the above example, and as a matter of course, suitable changes can be made without departing from the scope of the invention. Hereinafter, a modification will be described. The same components as in the above example are denoted by the same reference numerals and the description thereof is omitted. Differences from the above example will be mainly described.

### 4-1. Reference Value

In the above embodiment, the method for generating a reference value for a detected value of attitude and velocity detected during movement of the user is described. However, according to an experiment conducted by the inventor of the present application, it has been found that periodicity emerges also with respect to the acceleration measured by the acceleration sensor (local coordinate acceleration vector) and the angular velocity measured by the gyro sensor (local coordinate angular velocity vector) during movement of the user.

Thus, a reference value may be generated by a similar method to the foregoing embodiment, with respect to each component of the local coordinate acceleration vector (detected value of acceleration on each axis) measured by the acceleration sensor during movement of the user and each component of the local coordinate angular velocity vector (detected value of angular velocity about each axis) measured by the gyro sensor. That is, with respect to each component of the local coordinate acceleration vector and each component of the local coordinate angular velocity vector, a change portion of the detected value in the past that is similar to a change in the detected value up to the present is extracted. Then, a reference value for the detected value of each component of the local coordinate acceleration vector and each component of the local coordinate angular velocity vector is generated, based on the extracted change portion.

Also, in this case, a reference value may be generated for all the detected values of attitude, velocity, angular velocity and acceleration during movement of the user, or a reference value may be generated for the detected values of a part of these elements alone. That is, a reference value may be generated for the detected value of one of attitude, velocity, angular velocity and acceleration detected during movement of the user.

Also, it is possible to generate a reference value for a detected value of position that is used when correcting the detected value, other than attitude, velocity, angular velocity and acceleration. In this case, by carrying out similar correlation calculation to the foregoing embodiment, using an amount of change during a unit time in the absolute coordinate position calculated by the INS (hereinafter referred to as an “amount of position change”), it is possible to generate a reference value of the amount of position change.

In the case where the position itself is noted, since the user's position constantly changes during movement of the user, a good correlation may not be necessarily obtained even if correlation calculation with the detected value of the position itself detected in the past is carried out. However, it is assumed that the user moves (walks or runs) at the same pace to a certain extent. Therefore, in the case where the amount of position change per unit time (moving distance per unit time) is noted, the variance thereof is considered relatively small. Thus, with respect to the amount of position change, correlation between the amount of position change calculated this time and the amount of position change calculated in the past and stored cumulatively may be calculated, and a reference value of the amount of position change may be generated on the basis of the result of the correlation calculation.

### 4-2. Correction Method

In the foregoing embodiment, Kalman filtering is described as an example of a method for correcting the result of inertial navigation calculation. However, the correction method is not limited to this. For example, an error may be corrected using an averaging filter instead of Kalman filtering.

Specifically, averaging of the result of INS calculation (input vector “U”) calculated by the INS 10 and the reference value (observation vector “Z”) generated by the reference value generation unit 20 may be carried out and the result thereof may be outputted. In this case, for the averaging, simple arithmetic mean or geometric mean may be applied or weighted mean may be applied.

In the case of applying weighted mean, it is effective to set the weight of weighted mean, based on the degree of similarity between the transition of the detected value up to the present and the transition of the detected value in the past. Specifically, as the degree of similarly is higher, a higher weight for the reference value is set so that the reference value is trusted in the weighted mean. On the other hand, as the degree of similarity is lower, a lower weight for the reference value is set so that the result of INS calculation is trusted in the weighted mean. Also, other than these methods, arbitrary methods can be applied as a correction method by the correction unit.

### 4-3. Determination of Similarity

In the foregoing embodiment, the case where correlation calculation is carried out in order to extract a change portion of the detected value in the past that is most similar to a change in the detected value up to the present is described as an example. However, the method for extracting a change portion is not limited to this. For example, a change portion of the detected value in the past that is most similar to a change in the detected value up to the present may be extracted by using a peak detection method. Also, a change portion of the detected value in the past that is most similar to a change in the detected value up to the present may be extracted by using a pattern matching method.

Also, the foregoing embodiment describes that when carrying out correlation calculation, a change in the detected value in a predetermined time range in the past that is similar to a change in the detected value in the same time range lasting up to the present as a terminal point is extracted. However, the predetermined time range can be suitably set. For example, on the assumption that the user walks, a time range for determining similarity decided on the basis of the user's landing time interval may be used to extract a change in the detected value in the time range in the past that is similar to a change in the detected value in the time range lasting up to the present as a terminal point.

In this case, the time required for the user's one step is determined, for example, based on the result of measurement by the acceleration sensor. In this determination, for example, peak determination is carried out with respect to the acceleration of up and down movement of the user (acceleration in the w-axis direction). The time between neighboring peaks is the time required by the user for one step. Therefore, the time interval between the neighboring peaks may be determined and set as the landing time interval.

### 4-4. Method for Generating Reference Value

In the foregoing embodiment, for each of the velocity vector and the attitude angle, correlation calculation is carried out individually to generate a reference value. However, during the user's walk, a certain degree of correlation should appear between the transition of the velocity vector and the transition of the attitude angle. Thus, it is possible to omit the correlation calculation on one side.

In this case, correlation calculation is carried out with respect to only one of the velocity vector and the attitude angle. Then, when generating a reference value based on the result of the correlation calculation, the detected value at the same timing is read out to generate a reference value. That is, if correlation calculation is carried out only with respect to the velocity vector and a reference value is set for the velocity vector by shifting the value by the amount of shift corresponding to the correlation peak value, a reference value for the attitude angle is also set by shifting the value by the same amount of shift. Thus, the correlation calculation on one side can be omitted and the amount of calculation can be reduced.

### 4-5. Processing in Case of Low Degree of Similarity

The foregoing embodiment describes that the degree of similarity between the transition of the detected value up to the present and the transition of the detected value in the past is calculated with respect to each of the detected values of the local coordinate velocity vector and the attitude angle, and that if the highest degree of similarity of the calculated degrees of similarity does not satisfy a predetermined high similarity condition, the latest detected value is used to generate a reference value. However, if the degree of similarity between the transition of the detected value up to the present and the transition of the detected value in the past is low, the latest detected value need not necessarily be used to generate a reference value. That is, if the highest degree of similarity, of the degrees of similarity, does not satisfy a predetermined high similarity condition, the latest detected value may be simply saved as history in the storage unit without generating a reference value.

Also, in this case, the processing in the case where the degree of similarity does not satisfy a predetermined high similarity condition may be changed between the local coordinate velocity vector and the attitude angle. For example, if the degree of similarity calculated with respect to the local coordinate velocity vector does not satisfy a predetermined high similarity condition, the latest local coordinate velocity vector is simply saved as history in the storage unit without generating a reference velocity vector. On the other hand, if the degree of similarity calculated with respect to the attitude angle does not satisfy a predetermined high similarity condition, the latest attitude angle is used to generate a reference value. The same applies to the reverse case.

### 4-6. Agent of Processing

The foregoing example describes that an IMU is installed on an electronic apparatus and that the processing unit of the electronic apparatus carries out inertial navigation calculation processing based on the result of measurement by the IMU. However, an INS may be installed in an electronic apparatus and the processing unit of the INS may carry out inertial navigation calculation processing. In this case, the processing unit of the electronic apparatus carries out processing to estimate an error included in the result of inertial navigation calculation outputted from the INS (inertial navigation calculation error). Then, the result of inertial navigation calculation inputted from the INS is corrected, using the estimated inertial navigation calculation error.

Also, a sensor unit using a satellite positioning system such as GPS (Global Positioning System) may be installed on an electronic apparatus, and the result of inertial navigation calculation may be corrected using the result of measurement by this sensor unit.

### 4-7. Electronic Apparatus

In the foregoing example, the case where the invention is applied to an INS calculation device installed on the waist is described as an example. However, electronic apparatuses to which the invention is applicable are not limited to this. For example, the invention is also applicable to other electronic apparatuses such as a portable navigation device (portable navi), mobile phone, personal computer, and PDA.

### REFERENCE SIGNS LIST

1 overall system, 5A acceleration sensor, 5B gyro sensor, 10 INS, 11 attitude information calculation unit, 13 absolute coordinate acceleration vector calculation unit, 15 absolute coordinate velocity vector calculation unit, 17 absolute coordinate position calculation unit, 18 gravity calculation unit, 19 correction unit, 20 reference value generation unit, local coordinate velocity vector calculation unit, 23 reference velocity vector calculation unit, 25 attitude angle calculation unit, 27 reference attitude angle calculation unit, 30 error estimation unit, 100 processing unit, 200 operation unit, 300 display unit, 400 audio output unit, 500 INS, 600 storage unit, 1000 INS calculation device

1. A reference value generating method comprising:
storing a detected value of one of attitude, velocity, angular velocity, and acceleration detected during movement of a user, in a storage unit;
extracting a change portion of the detected value in the past that is similar to a change in the detected value up to the present, from the storage unit; and
generating a reference value of the detected value used when correcting the detected value, by using a result of the extraction.

2. The reference value generating method according to claim 1,
wherein the extracting includes extracting a change portion of the detected value in the past that is most similar to the change in the detected value.

3. The reference value generating method according to claim 1,
wherein the extracting includes calculating a degree of similarity between the change in the detected value up to the present and the change in the detected value in the past, and
the method includes generating the reference value by using the latest detected value if the highest degree of similarity of the calculated degrees of similarity does not satisfy a predetermined high similarity condition.

4. The reference value generating method according to claim 1,
wherein the extracting is, by using a time range for determination of the similarity defined on the basis of a landing time interval that is a time interval between neighboring peaks of acceleration of up and down movement of the user, extracting a change in the detected value in the time range in the past that is similar to a change in the detected value in the time range lasting up to the present as a terminal point.

5. The reference value generating method according to claim 1,
wherein the storage unit has a capacity equal to or greater than a predetermined capacity defined as a capacity for storing the detected value detected while the user takes two steps.

6. The reference value generating method according to claim 1, comprising:
performing Kalman filtering to find an amount of correction of the detected value, using the reference value as observation information;
correcting the detected value based on the amount of correction; and
calculating the position using the detected value.

7. The reference value generating method according to claim 1,
wherein at least a value indicating a velocity vector in absolute coordinates during movement of the user is included in the detected value, and
the method includes:
adding up acceleration vectors defined on the basis of a measured value from an acceleration sensor and thus finding the velocity vector in the absolute coordinates;
adding up the velocity vectors and thus calculating a position in the absolute coordinates: and
correcting one of the adding up of the acceleration vectors and the adding up of the velocity vector, using the reference value.

8. A reference value generating device comprising:
a storage unit that stores a detected value of one of attitude, velocity, angular velocity, and acceleration detected during movement of a user;
an extraction unit that extracts a change portion of the detected value in the past that is similar to a change in the detected value up to the present, from the storage unit; and
a generation unit that generates a reference value of the detected value used when correcting the detected value, by using a result of the extraction.
